(19) United States
(12) Patent Application Publication
(10) Pub. No.: US 2020/0129984 A1
(43) Pub. Date: Apr. 30, 2020

(54) BLOW-IN INSULATION MATERIAL MADE OF STRAW

(71) Applicant: Leopold KASSECKERT, Kasten (AT)

(72) Inventor: Leopold KASSECKERT, Kasten (AT)

(21) Appl. No.: 16/495,929

(22) PCT Filed: Mar. 23, 2018
(86) PCT No.: PCT/EP2018/057389

§ 371 Date: Sep. 20, 2019

(30) Foreign Application Priority Data
Mar. 24, 2017 (EP) 17162840.7

(51) Int. Cl. B02C 4/08; B02C 4/30

(52) U.S. Cl. CPC B02C 4/08; E04B 1/80; B02C 4/30

(57) ABSTRACT

Process for manufacturing a blow-in insulation material made of straw, including a processing step in which the straw is crushed between rolls in a crushing apparatus, a crushing nip in the crushing apparatus being selected in such a way that the straw nodes are crushed during the crushing operation.

### CROSS-REFERENCE TO RELATED APPLICATIONS

This application is a national phase application of PCT Application No. PCT/EP2018/057389, filed Mar. 23, 2018, entitled “BLOW-IN INSULATION MATERIAL MADE OF STRAW”, which claims the benefit of European Patent Application No. 17162840.7, filed Mar. 24, 2017, each of which is incorporated by reference in its entirety.

### FIELD OF THE INVENTION

The invention relates to a method for producing an insulation material (in particular a thermal insulation material) made of straw, including a processing step in which the straw is crushed, and to a device for producing an insulation material made of straw with a crushing apparatus for crushing the straw, and to an insulation material including comminuted straw.

### BACKGROUND

Methods and devices of this kind are intended to produce a loose and pourable insulation material made of straw. The invention is not limited to insulation materials which consist exclusively of straw, but also relates to the production of insulation materials that can also contain other raw materials besides straw. For example straw can form the foundation or basis of an insulation material of which the properties can be changed by additives and adapted to specific requirements.

For the insulation of practically any cavities, in particular in buildings, the use of blow-in insulation material has increased. The insulation material either can be blown into cavities in the erected walls of the building or can be blown into prepared finished parts (for example complete wall elements) prior to erection. An advantage of this type of insulation is that it can be introduced without joints or cuts, and this can be performed more quickly and with less material loss, for example as compared to the introduction of insulating mats. Thermal insulation materials made of cellulose, wood fibers, mineral fibers, mineral granular materials or EPS granular materials are currently used as blow-in insulation materials.

The use of an insulation material made of straw has the advantage, compared to the described materials, that the raw material is a waste product of food production and therefore is available comparatively favorable and in large amounts. Due to the silicic acid present in the straw, an insulation material made of straw also has favorable properties from a fire protection viewpoint, and there is generally no need for any chemical additives in order to improve the fire behaviour. The use of insulation material made of straw is also advantageous from an ecological viewpoint.

Previously, however, it was not possible to use straw to produce an insulation material which can be used with conventional and now widespread blow-in machines for the above-mentioned and now common blow-in materials, i.e. an insulation material which can be blown in using these machines at a suitable level of compaction.

The blowing-in of untreated chopped straw as insulation material is known in principle from EP 2 360 326 B1. However, it has been found that it is not possible merely by chopping to produce an insulation material that can be blown in using conventional blow-in machines at a suitable level of compaction (at least 90-130 kg/m³). Accordingly, in the method described in EP 2 360 326 B1 the chopped straw is firstly fed in mechanically optimised form into a horizontal component, the component is then shaken to achieve compaction, and additional insulation material is then introduced as necessary by being blown in.

Document DE 198 10 862 A1 presents an insulation panel produced from straw and a method for producing same. In that case the straw is comminuted and spliced and is split into straw fibers. The splicing is performed along the length of the stalk, wherein the closed stalk structure is destroyed. For the presented use (production of an insulation panel) the resultant material must be mixed with binder and consequently cannot be blown in.

Document WO 2013/017687 A2 additionally discloses the processing of straw in what is known as an impact reactor for production of a blow-in insulation material. The straw is comminuted and processed in the impact reactor in a non-cutting or non-material-removing method. More precisely, the comminution is achieved by subjecting the material to violent impacts.

Besides the production of insulation material, further methods for processing straw are known. For example, document DE 8 229 421 U1 presents a fiberisation machine having three splined shafts mounted rotatably in a housing with rotation axes arranged parallel to one another. The teeth of the splined shafts do not mesh with one another in the circumferential direction, but instead extend next to one another, wherein the individual splined shafts are operated at different rotation speeds and directions. The straw is fiberised in this case between the teeth running next to one another.

Document US 2015/129698 A1 presents a method and a device for producing feed, wherein in particular the objective is to provide stalk fibers that can be better digested. In accordance with this purpose, the feed material contains not only stalks, but also grain and leaves, and therefore is not straw. This feed material is firstly conveyed through a chopper and then is conveyed between two rotating rollers. It is sought to avoid excessive comminution of the stalks.

JP 2007 068499 A discloses a mill for feed rice. This mill has two rollers with circumferential grooves with a V cross-section, which rotate in opposite directions. The rollers preferably rotate at different speeds.

In conjunction with a pulverisation of straw, for example for use as biomass fuel, document CN 204974018 U presents a straw mill having three cylindrical, horizontal, splined rollers. It remains open, however, as to what function the rollers perform or how they alter the straw and at what distance the rollers are arranged from one another. Since the straw is fed vertically and without special conveying equipment, it is assumed that the straw is poured from above into the device. The distance between the rollers must therefore be large enough to prevent the rollers from becoming blocked, even in the case of straw bundles that are stuck together.

In document DE 199 00 098 A1, which lies in a completely different field, a device and a method for defacing coins are presented. In this case the coins are deformed between two profiled rollers and are thus defaced.

### SUMMARY

The object of the invention is to enable an efficient production of an insulation material made of straw using conventional blow-in machines at a suitable level of compaction (at least 120 kg/m³).

The method according to the invention of the kind described at the outset provides that the straw is crushed between at least two opposite rollers rotating in opposite directions, wherein the opposite rollers each rotate at substantially the same circumferential speed, and that the straw nodes are crushed during the crushing operation. It has been found that with the use of chopped straw in which the nodes are not crushed, with a conventional blow-in machine it is possible to attain a compaction of at most 80 kg/m³. A conventional blow-in machine typically achieves a maximum conveying pressure of 400 mbar with a diameter of the outlet opening of approximately 7.6 cm (3 inches). The invention is based on the finding that the low compaction previously attainable can be attributed to the high structural robustness of the straw nodes. The method according to the invention therefore proposes crushing these nodes, i.e. at least a significant proportion of these nodes (for example more than 20%, in particular more than 50% of the nodes). As has been found, a compaction greater than 100 kg/m³, in particular greater than 120 kg/m³, can be attained with the straw processed in this way when it is blown in using a conventional blow-in machine.

The circumferential speed of the two rollers can be between 20 and 60 m/s, for example. By way of the substantially equal circumferential speed, it can be ensured that the straw is not excessively ground and fiberised between the rollers, because the advantageous insulation properties would then be compromised. The use of rollers has the advantage that the straw can be processed in a continuous process (which is not the case in a press, for example), which reduces the susceptibility of the processing to faults. The rollers may be fabricated for example from steel, although in principle any material which during operation (i.e. at the used rotation speed) transfers a sufficient force to the nodes in order to crush and squash them is suitable.

Accordingly, the device according to the invention of the kind described at the outset provides that the crushing apparatus has at least two opposite rollers mounted rotatably about parallel axes of rotation and is designed to crush the nodes of the straw, wherein the crushing apparatus is designed to drive the rollers in opposite directions at substantially the same circumferential speed and to (continuously) guide the straw between the rollers, and wherein a downstream comminution apparatus is connected to the crushing apparatus in such a way that during operation the straw crushed in the crushing apparatus is fed to the downstream comminution apparatus. In particular a crushing gap of the crushing apparatus can be selected such that the straw nodes are crushed in the crushing apparatus during the crushing operation.

In the insulation material according to the invention the straw nodes are crushed accordingly. A significant proportion of the nodes can therefore have in particular breaks or cracks in a node wall. The density and compressibility of the insulation material mean that the material can be blown into a cavity that is to be insulated using a conventional blow-in machine at a compaction of more than 100 kg/m³, preferably between 100 and 150 kg/m³, in particular between 120 and 130 kg/m³. The insulation material according to the invention preferably is a blow-in material. The insulation material according to the invention can preferably consist substantially of comminuted straw, wherein the nodes of the straw are crushed. In other words, any other constituents or additives preferably account for such a small part of the insulation material that the blow-in properties of the insulation material are not significantly negatively influenced thereby. In other words, the type and amount of any additives is low enough that the insulation material on the basis of blow-in straw remains suitable for being blown in also together with the additives.

The region of the plant stem at which one or more leaves is/are positioned is referred to as the node (Latin: nodus). Straw stalks are often thicker in the region of a node, which leads to a greater strength and a greater resistance to compression. During the crushing operation the nodes or nodules are squashed and partially broken. The crushing or squashing occurs between two surfaces, which are pressed against one another.

In conjunction with the crushing of the nodes it has proven to be advantageous if the stalks of the straw are separated prior to the crushing. The proportion of the crushed nodes can thus be increased, because otherwise nodes arranged one above the other could prevent adjacent individual nodes from being crushed. In the case of the present device it is therefore advantageous if the straw is fed to the crushing apparatus, which is designed to separate the stalks of the straw prior to the crushing operation.

It has been found to be particularly suitable for a gap width of a crushing gap during the crushing of the straw to be between 0.8 and 1.6 mm, preferably between 1.0 and 1.4 mm, in particular approximately 1.2 mm. Accordingly, it is favorable if the crushing apparatus has a gap width of a crushing gap of the crushing apparatus between 0.8 and 1.6 mm, preferably between 1.0 and 1.4 mm, in particular approximately 1.2 mm. These gap widths have been determined as particularly suitable for cereal straw, in particular wheat straw. The crushing gap is comparable to a grinding gap in other kinds of applications which often include not only crushing, but also friction. The gap width of the crushing gap defines the cross-section to which the straw inclusive of the nodes is crushed.

Depending on the type and structure of the processed straw, other gap widths can of course be selected in order to attain the desired compaction as the resultant insulation material is blown in. It is therefore favorable if, in the case of the present device, the crushing gap of the crushing apparatus is adjustable.

It is also advantageous if the crushing apparatus allows a continuous processing of the straw. A continuous processing is generally less susceptible to faults as compared to an individual processing of separate batches, both in respect of the loading of mechanical components and in respect of an optimal control of the device.

In conjunction with the use of rollers to crush the straw it is advantageous if the rollers have axis-parallel or oblique grooves. In particular the rollers can be designed as splined rollers or splined shafts. The conveying function of the rollers, which perform this function in addition to the crushing function, is thus improved, with the straw being received in the grooves.

With the use of rollers with grooves it is particularly favorable if the rollers mesh with one another in the manner of a spur gearing. In this case the regions between the grooves of the rollers form the teeth, which engage in the grooves of opposite rollers in the circumferential direction. The toothing between two rollers can be provided here as a straight toothing, oblique toothing or double oblique toothing, wherein the teeth and grooves of the rollers are adapted accordingly.

Alternatively or additionally to the grooves, at least one roller can have a structured (i.e. a non-smooth) surface. The structure of the surface is preferably selected such that the friction is increased in the circumferential direction (for example a structuring with ribs or notches running perpendicularly or obliquely to the rotation axis or with indentations or elevations at specific points, for example in the form of nubs or spikes). Since the friction with the conveyed straw is increased, it is possible to counteract a clogging of the crushing apparatus.

It has also proven to be advantageous in respect of the rollers if at least one roller is spring-mounted. The mounting in this case is displaceable, such that the distance between opposite rollers can be increased temporarily and against the return force of the spring system, i.e. the crushing gap can be increased. The spring system can be set such that incompressible contaminations (for example stones) can be conveyed by the rollers and the rollers are not blocked as a result. The spring system is preferably coordinated with the rigidity of the nodes of the straw, i.e. is set at least to be hard enough that the nodes of the straw are crushed.

For the feed of the straw between the rollers it has proven to be particularly favorable if the straw is sucked in between the rollers. Separated straw stalks can thus be fed efficiently and quickly. An advantage of the suction is that the feed rate of the straw can be adjusted by application of a suitable pressure difference. A further advantage of the suction is that the dust formation during the processing can be controlled. In practice the system is switched on “from the rear”, i.e. starting with a suction apparatus, followed by the individual processing machines upstream. Alternatively, the straw can be blown in between the rollers (for example using a blow-in apparatus), wherein the dust formation, however, and in particular the discharge of dust during the processing into the surroundings is difficult to control.

Accordingly, the device according to the invention can preferably include a suction apparatus for conveying the straw through the crushing apparatus. The suction apparatus can be arranged in particular downstream of the crushing apparatus and can be connected to an outlet of the crushing apparatus in a substantially airtight manner The suction apparatus can thus generate a negative pressure in the crushing apparatus. If the crushing apparatus is formed by at least two opposite rollers, a continuous and uniform feed of straw between the rollers can be attained, for example with a nozzle arranged upstream of the rollers, the nozzle having a flat opening which opens out in the direction of the crushing gap between the rollers. For example, a flat pressed blow-in tube can be used as a nozzle, wherein the width of the nozzle preferably corresponds to approximately the length of the rollers, for example approximately 30 cm.

In order to improve the reliability of the device, at least two crushing apparatuses can be provided, which preferably can be connected to a common suction apparatus. The suction apparatus in comparison to the crushing apparatuses has a higher reliability, i.e. shutdown of the device is caused more frequently by a clogging or blocking of a crushing apparatus than by a failure of the suction apparatus. In the case of at least two crushing apparatuses, one can continue to be operated whilst the other is serviced. In addition a higher throughput can be attained with two or more crushing apparatuses, wherein the device only has to be slightly increased in size because the crushing apparatus is comparatively small in relation to the suction apparatus and at the same time is the limiting factor for maximum throughput.

The rotation speed of the rollers is preferably set such that the circumferential speed of the rollers is greater than the airspeed of the sucked-in (or blown-in) straw. At a lower circumferential speed the likelihood of clogging increases and can lead to a stalling of the crushing apparatus on account of the limited power of the drive. On the other hand, if the rotation speed is too high, this can lead to an unnecessarily high mechanical loading of the rollers and a higher energy consumption of the drive. An optimal rotation speed can be determined in practice by trying and adapting the feed rate of the straw or coordinating it with the pressure difference attained by a suction apparatus.

It has also proven to be favorable if the stalks of the straw are comminuted prior to the crushing and the comminuted stalks are crushed. The stalks for example can be chopped prior to the crushing, preferably in a straw mill. The length of the stalks comminuted in this way can be preferably up to 4 cm. Accordingly, the device according to the invention can preferably include an upstream (first) comminution apparatus, which is connected to the crushing apparatus in such a way that during operation the straw comminuted and/or spliced in the upstream comminution apparatus is fed to the crushing apparatus.

It is additionally advantageous if the straw is comminuted after the crushing (anew and additionally as appropriate). This can be achieved for example likewise by chopping, preferably in a straw mill. The length of the resultant crushed stalk pieces can be in particular between 20 and 40 mm. It has been found that in this way the likelihood of blockages of the blow-in machine can be reduced. Accordingly—and for differentiation from devices for other applications which require comminution to a lesser extent—the device according to the invention includes a downstream comminution apparatus which is connected to the crushing apparatus in such a way that during operation the straw crushed in the crushing apparatus is fed to the second comminution apparatus. In order for the straw to retain its advantageous properties as insulation material it is advantageous if it is not comminuted too heavily. In particular, fiber lengths of the straw up to at least 2 mm, preferably up to at least 5 mm, in particular up to at least 25 mm should be maintained.

Lastly, it has proven to be particularly advantageous if the straw has a relatively high degree of purity (i.e. in comparison to other degrees of purity obtainable on the market). A lower degree of purity indicates a considerable contamination by weeds. With use of straw of the above-specified degree of purity, optimal values for the compaction can be attained with the resultant insulation material.

In conjunction with the device according to the invention it has proven to be particularly favorable if the device can be installed in an ISO container. In other words the outer dimensions of the device are preferably smaller than the inner dimensions of an ISO container. The length of the device is preferably less than 5.9 m (20-foot ISO container) or less than 12 m (40-foot ISO container), the width of the device is preferably less than 2.35 m, and the height of the device is preferably less than 2.38 m. The weight of the device is preferably less than 21.67 tonnes or less than 26.46 tonnes. A device installed in an ISO container can be provided as a transportable production box. This facilitates the transportation of the device to a location where a large amount of insulation material is required and straw is available. The transportation of the device then saves transportation of the straw and is thus advantageous in particular from an ecological viewpoint. The device can preferably include an integrated motor, which drives at least the crushing apparatus, and therefore, apart from straw, only power or fuel are necessary for operation at a selected location.

### BRIEF DESCRIPTION OF THE DRAWINGS

The invention will be explained in greater detail hereinafter on the basis of particularly preferred exemplary embodiments, to which the invention is not limited, however, and with reference to the drawings, in which specifically:

FIG. 1 schematically shows an overview of a device according to the invention for producing an insulation material made of straw with a crushing apparatus;

FIG. 2 schematically shows a section of the crushing apparatus according to FIG. 1 with three rollers;

FIG. 3 schematically shows the basic outline of the crushing apparatus according to FIGS. 1 and 2; and

FIG. 4 schematically shows a detailed view of the section according to FIG. 2, wherein the sections of the rollers are shown true to scale.

### DETAILED DESCRIPTION

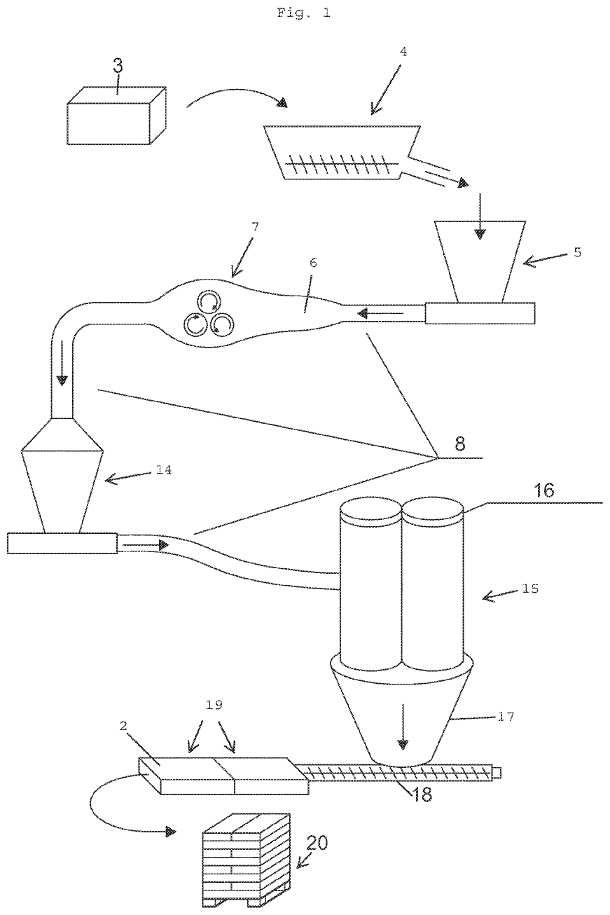

FIG. 1 shows a device 1 for producing an insulation material 2 made of straw 3. The arrows indicate the direction of movement of the processed material. The straw 3, which is present for example in the form of balls, is firstly introduced into a preprocessing unit 4. In the preprocessing unit 4 the straw 3 is loosened and comminuted. The loosened and comminuted straw is then transferred to (for example poured into) an upstream first comminution apparatus 5, which is arranged downstream of the preprocessing unit 4. In the first comminution apparatus 5 the straw stalks are comminuted to a length of approximately 4 cm. The first comminution apparatus 5 can be, for example, a straw mill from the manufacturer voran Maschinen GmbH, Austria.

The straw comminuted in the first comminution apparatus 5 is fed with the aid of a feed 6 to a crushing apparatus 7 of the device 1. Starting with the first comminution apparatus 5, the straw is guided in a substantially airtight air channel system 8 of the device 1. The lines and connections of the air channel system 8 are designed such that they withstand a static negative pressure of approximately 2200 Pascal.

The feed 6 is designed in the manner of a nozzle with a flat opening 9 (see FIG. 2). The feed 6 is designed to separate the stalks of the straw prior to the crushing so that preferably individual straw stalks are fed the crushing apparatus 7.

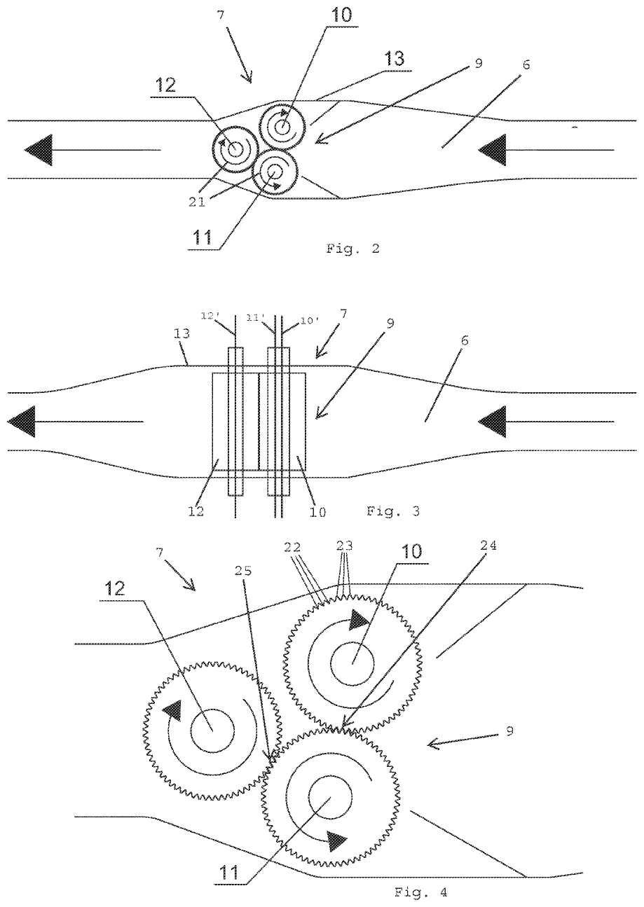

The crushing apparatus 7 is designed to crush the straw. The crushing apparatus 7 includes three rollers 10, 11, 12, which are mounted in the housing 13 so as to be rotatable about parallel rotation axes 10′, 11′, 12′ (see FIG. 2-4). The rollers 10, 11, 12 are arranged oppositely in pairs and form a first roller pair 10, 11 and a second roller pair 11, 12. The opposite rollers 10, 11, 12 of a roller pair are driven in opposite directions during operation, or the device 1 is designed to drive the rollers in opposite directions. The circumferential speed of the rollers 10, 11; 11, 12 of a pair are substantially the same. During operation of the shown arrangement the circumferential speeds of all rollers 10, 11, 12 of the crushing apparatus 7 are the same because the second, middle roller 11 belongs to both roller pairs 10, 11; 11, 12. The straw stalks coming from the feed 6 are firstly sucked in between the rollers 10, 11 of the first roller pair on account of the negative pressure. The circumferential speed of the rollers 10, 11, 12 is slightly greater here than the airspeed of the straw stalks, and so the straw stalks are discouraged from collecting in front of the first roller pair 10, 11. A portion of the straw nodes is crushed between the rollers 10, 11 of the first roller pair, whilst the straw is conveyed to the second roller pair 11, 12 on account of the rotation of the rollers 10, 11. A further portion of the nodes of the straw is crushed between the rollers 11, 12 of the second roller pair.

Downstream of the crushing apparatus 7, the device 1 has a downstream second comminution apparatus 14. The second comminution apparatus 14 is connected to the crushing apparatus 7 in such a way that during operation the straw crushed in the crushing apparatus 7 is fed to the second comminution apparatus 7. In the second comminution apparatus 14 the crushed straw stalks are comminuted to a length between 10 and 20 mm. The second comminution apparatus 14 can be, for example, a straw mill from the manufacturer voran Maschinen GmbH, Austria.

The device 1 also includes a suction apparatus 15. For example, a suction apparatus 15 from the manufacturer Holzprofi Pichlmann GmbH, Austria can be used. The suction apparatus 15 supports the conveying of the straw stalks through the two comminution apparatuses 5, 14 and through the crushing apparatus 7 by generating a negative pressure in the air channel system 8. In accordance with the shown production line at least one second production line (with separate crushing apparatus and comminution apparatuses) can be connected to the same suction apparatus 15, so that the suction apparatus 15 collects straw stalks from a plurality of production lines. The schematically shown suction apparatus 15 discharges the filtered waste air 16 upwardly and guides the produced insulation material downwardly into a funnel-shaped straw trap 17 by way of overpressure. The insulation material is compacted in the straw trap 17 and is dispensed into a conveying screw 18. The conveying screw 18 compresses the insulation material to a desired packaging density of approximately 130-170 kg/m3 for filling a packaging 19, for example a bag. The filled packagings 19 are then stacked for delivery on pallets 20 and are transported to the site of use, where the insulation can be produced by filling the packaging content into a conventional blow-in machine.

FIGS. 2 to 4 show the crushing apparatus 7 according to FIG. 1 in greater detail. The direction of rotation of the rollers 10, 11, 12 is shown by direction arrows 21. As is discernible on the basis of the shown roller profiles, the rollers 10, 11, 12 have axis-parallel grooves 22. The regions between the grooves 22 are formed as teeth 23. The rollers 10, 11; 11, 12 of a roller pair, in particular the teeth 23 and grooves 22 thereof, mesh with one another in the manner of a spur gearing, as can be seen in particular in FIG. 4. The diameter of the rollers in this exemplary embodiment is 120 mm in each case. The rollers each have 68 teeth with a tooth depth of approximately 6 mm.

Between the rollers 10, 11; 11, 12 of a roller pair the crushing apparatus 7 has a crushing gap 24, 25. The crushing gap 24, 25 is the smallest gap between the rollers 10, 11; 11, 12 of a roller pair in the radial direction. In the present example the crushing gap 24, 25 corresponds in each case to the distance between the radial outer surface of a tooth 23 of a roller and the radial inner surface of a groove 22 of the opposite roller. The gap width of the crushing gap 24, 25 is adjustable, for example with a displaceable bearing (see below), and in the shown position is approximately 1.2 mm. In this position the crushing apparatus 7 is designed to crush the nodes of wheat straw.

The two upper rollers 10, 12, which are associated with different roller pairs 10, 11; 11, 12, are spring-mounted. In other words the bearings of these rollers 10, 12 are not rigidly connected to the bearing of the middle roller 11, but instead are displaceable from the bearing of the middle roller 11 against the return force of a spring normal to the rotation axis of the middle roller 11. The return force of the spring is approximately 10-25 kN.

1-15. (canceled)

16. A method for producing an insulation material made of straw, comprising:
crushing the straw,
wherein the straw is crushed between at least two opposite rollers rotating in opposite directions,
wherein the opposite rollers each rotate at substantially the same circumferential speed, and
wherein the straw nodes are crushed during the crushing operation.

17. The method according to claim 16, wherein the stalks of the straw are separated prior to the crushing operation.

18. The method according to claim 16, wherein the gap width of a crushing gap during the crushing operation of the straw is between 0.8 and 1.6 mm.

19. The method according to claim 16, wherein the gap width of a crushing gap during the crushing operation of the straw is between 1.0 and 1.4 mm.

20. The method according to claim 16, wherein the gap width of a crushing gap during the crushing operation of the straw is approximately 1.2 mm.

21. The method according to claim 16, wherein the rollers have axis-parallel or oblique grooves.

22. The method according to claim 16, wherein the straw stalks are comminuted prior to the crushing operation and the comminuted stalks are crushed.

23. The method according to claim 16, wherein the straw is comminuted after the crushing operation.

24. A device for producing an insulation material made of straw, comprising:
a crushing apparatus for crushing the straw,
wherein the crushing apparatus has at least two opposite rollers mounted rotatably about parallel rotation axes,
wherein the crushing apparatus is designed to crush the straw nodes,
wherein the crushing apparatus is designed to drive the rollers in opposite directions at substantially the same circumferential speed and to guide the straw between the rollers, and
wherein a downstream comminution apparatus is connected to the crushing apparatus in such a way that during operation the straw crushed in the crushing apparatus is fed to the downstream comminution apparatus.

25. The device according to claim 24, wherein a feed of the straw to the crushing apparatus which is designed to separate the stalks of the straw prior to the crushing.

26. The device according to claim 24, wherein the crushing apparatus has a gap width of a crushing gap of the crushing apparatus is between 0.8 and 1.6 mm.

27. The device according to claim 24, wherein the crushing apparatus has a gap width of a crushing gap of the crushing apparatus is between 1.0 and 1.4 mm.

28. The device according to claim 24, wherein the crushing apparatus has a gap width of a crushing gap of the crushing apparatus is approximately 1.2 mm.

29. The device according to claim 24, wherein the rollers have axis-parallel or oblique grooves.

30. The device according to claim 24, wherein the rollers mesh with one another in the manner of a spur gearing.

31. The device according to claim 24, wherein at least one roller is spring-mounted.

32. The device according to claim 24, wherein an upstream comminution apparatus, which is connected to the crushing apparatus in such a way that during operation the straw comminuted in the upstream comminution apparatus is fed to the crushing apparatus.

33. An insulation material comprising comminuted straw, wherein the straw nodes are crushed.

34. The insulation material according to claim 33, wherein the insulation material consists substantially of comminuted straw, wherein the straw nodes are crushed.
